(19) United States
(12) Patent Application Publication
(10) Pub. No.: US 2006/0004596 A1
(43) Pub. Date: Jan. 5, 2006

(54) Business process outsourcing

(76) Inventors: Jim Caniglia, Cave Creek, AZ (US); Kannan Ramachandran, Phoenix, AZ (US); Vipul Khanna, Mumbai Maharashtra (IN)

Correspondence Address: MICHAEL BEST & FRIEDRICH, LLP, 100 E WISCONSIN AVENUE, MILWAUKEE, WI, 53202, US

(21) Appl. No.: 11/159,819

(22) Filed: Jun. 23, 2005

Related U.S. Application Data
(60) Provisional application No. 60/583,087, filed on Jun. 25, 2004.

(51) Int. Cl. G06Q 99/00

(52) U.S. Cl. 705/1

(57) ABSTRACT

Systems and methods for determining an outsourcing readiness for business processes. The method can include defining process characteristics for the business processes, determining a readiness index for the business processes based on the process characteristics for the business processes, and ranking the at least one business processes according the readiness index for the business process.

### RELATED APPLICATIONS

The present application claims priority to U.S. Provisional Patent Application Ser. No. 60/583,087 entitled “BUSINESS PROCESS OUTSOURCING,” filed on Jun. 25, 2004, the entire contents of which are herein incorporated by reference.

### SUMMARY OF THE INVENTION

Taking the first steps towards outsourcing business processes can be difficult and selecting the right processes to outsource can be one of the most critical issues. Process selection involves decision making on a number of different levels, including which processes to outsource; what interrelated activities or business units need to be considered when outsourcing a complete business unit or function; should the process be improved first or should it be moved “as is;” which tasks within a process should be outsourced and which should be retained in-house; how should the various processes be sequenced for outsourcing; and what risks should be considered.

In light of the above difficulties, some embodiments of the invention provide a method for helping clients make these decisions with confidence. Some embodiments of the invention further provide a method for a smooth transition of activities from one operation to another.

In general, some embodiments of the invention relate to identifying business processes to outsource. In particular, one embodiment of the invention relates to assigning a process-ready index to a business process that specifies the ease and success of outsourcing the business process. Some embodiments of the invention also relate to transitioning a business process once it has been identified as an outsourcing candidate.

One embodiment of a method of the invention can include defining process characteristics for a business process, determining a readiness index for the business process based on the process characteristics for the business process, and ranking the business process according the readiness index.

Some embodiments of the invention provide a system for determining an outsourcing readiness for a business process. The system can include a process readiness index calculating tool including an input/output module configured to receive process characteristics associated with the business process and a processor configured to receive the process characteristics, determine a readiness index for the business process based on the process characteristics, and rank the business process according the readiness index.

Additional embodiments of the invention provide a computer readable medium containing instructions for determining an outsourcing readiness for a business process. The computer readable medium can include instructions for defining process characteristics for the business process, determining a readiness index for the business process based on the process characteristics, and ranking the business process according the readiness index.

### BRIEF DESCRIPTION OF THE DRAWINGS

FIG. 1 illustrates a business process outsourcing method according to one embodiment of the invention.

FIG. 2 schematically illustrates steps for executing a business process transition during the business process outsourcing method of FIG. 1.

FIG. 3A illustrates a project checklist according to one embodiment of the invention.

FIG. 3B illustrates a project team framework according to one embodiment of the invention.

FIG. 4 illustrates a process screening method according to one embodiment of the invention.

FIGS. 5A and 5B illustrate a process readiness index calculation algorithm including characteristic groups according to one embodiment of the invention.

FIGS. 6A-6C illustrate characteristic groups and examples of some of the characteristic types contained within each group.

FIG. 7 illustrates a process profile and interview form according to one embodiment of the invention.

FIG. 8 illustrates a formula for determining a process readiness index according to one embodiment of the invention.

FIGS. 9A-9E illustrate examples of process diagrams.

FIGS. 10A-10C illustrate portions of a process readiness input worksheet according to one embodiment of the invention.

FIG. 11 illustrates a summary process readiness index report according to one embodiment of the invention.

FIGS. 12A and 12B illustrate individual process readiness reports according to one embodiment of the invention.

FIGS. 13A-13C illustrate examples of individual process readiness index reports with inferred conclusions.

FIG. 14 illustrates a computing system including a process readiness index calculating tool according to one embodiment of the invention.

FIG. 15 illustrates a post-outsource communication plan according to one embodiment of the invention.

FIG. 16 illustrates a standard call volume report according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and software components or modules. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

Business process outsourcing can provide a number of advantages to an organization including one or more of the following: reducing costs, increasing returns on investments, providing access to functional and industry expertise, improving process performance, providing access to the best technology, benefiting from sharing of best practices, freeing up resources for other uses, converting fixed costs to variable costs, improving speed to market, providing easier integration during mergers and acquisitions, converting cost centers into profit centers, providing greater operational flexibility, improving customer service quality, and transforming existing processes.

Considering outsourcing, however, can require an organization to clearly define its goals and objectives. A commonly asked question is what should be outsourced, and more importantly, how should the business processes most suitable to be outsourced be identified. Selecting processes can begin with seeking alignment on business goals and the relative importance of different objectives.

Certain characteristics of business process may make a process well suited for outsourcing. Many processes in the financial services, retail, and telecommunications sector fulfill these criteria by focusing on these three specific business verticals, processes within these industries can be identified as potential outsourcing candidates. Processes that are candidates for potential outsourcing can include financial applications, such as accounts payable, accounts receivable, billing and invoicing, account reconciliation, etc. Outsourcing candidates can also include customer service applications, such as authorization calls, charge backs and related queries, new account policies, credit and collection, underwriting procedures, inbound direct marketing calls, collection calling, customer correspondence, customer database maintenance, customer inquiries, customer invoicing, email responses and online chat services, basic contact center interaction, etc. Still other outsourcing candidates include processes related to transaction intensive applications, such as new account set-up, account transfers, payment processing, claims processing, data transcription, exception processing, forms processing, keyboard data entry, order processing, etc.

Characteristics shared by the above processes may cause them to be candidates for outsourcing. For example, a transaction that is processed in a standardized manner lends itself to be outsourced. Variations of a single process can also be prime outsourcing candidates. However, if the majority of the steps of a process are unique, the process may not be an ideal process to outsource, because it may be difficult to maximize efficiencies gained in outsourcing. Transactions that can be cloned, e.g., they are repeatable in most or all respects, may also be appropriate for outsourcing, because each transaction is processed in the same way as a previous transaction and a subsequent transaction. Outsource candidate processes can also include processes that have a high volume. Economies of scale typically do not permit standard or repeatable processes that have a very low volume to be outsourced. It may also be necessary that a potentially-outsourced process be able to be separated from the core business without detriment to the residual parts of the processes being retained in the organization, and vice versa. In other words, the outsourced process, when completed by the outsourcer, should seamlessly integrate with the processes retained by the host organization. The complexity of a process may also be considered. Clearly, moving simple processes may be easy and stress-free, but more complex processes may provide significantly more value if outsourced.

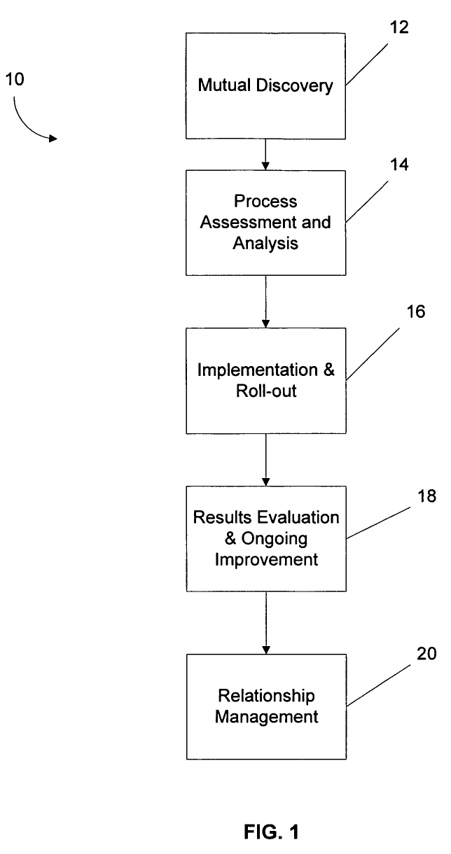

Some embodiments of the invention not only identify which processes are ripe for outsourcing, but also rank order each individual process so that the best results are achieved in decisions to outsource. The ranking can be a “portfolio analysis” of business processes that identifies potential candidates for outsourcing. The process of ranking business process can include a number of steps in order to successfully determine the suitability of a particular process for outsourcing. Even after a business process has been selected for outsourcing based on the ranking, a long path may be followed to actually outsource the process and manage the process after it has been transitioned. FIG. 1 shows the key phases involved in a business process outsourcing (“BPO”) project from the initial discovery through ongoing relationship management.

As shown in FIG. 1, some embodiments of the invention provide a method 10 for successfully outsourcing business processes. The method 10 includes various methodologies used to identify a set of processes to be outsourced and details about each candidate process in the set of processes.

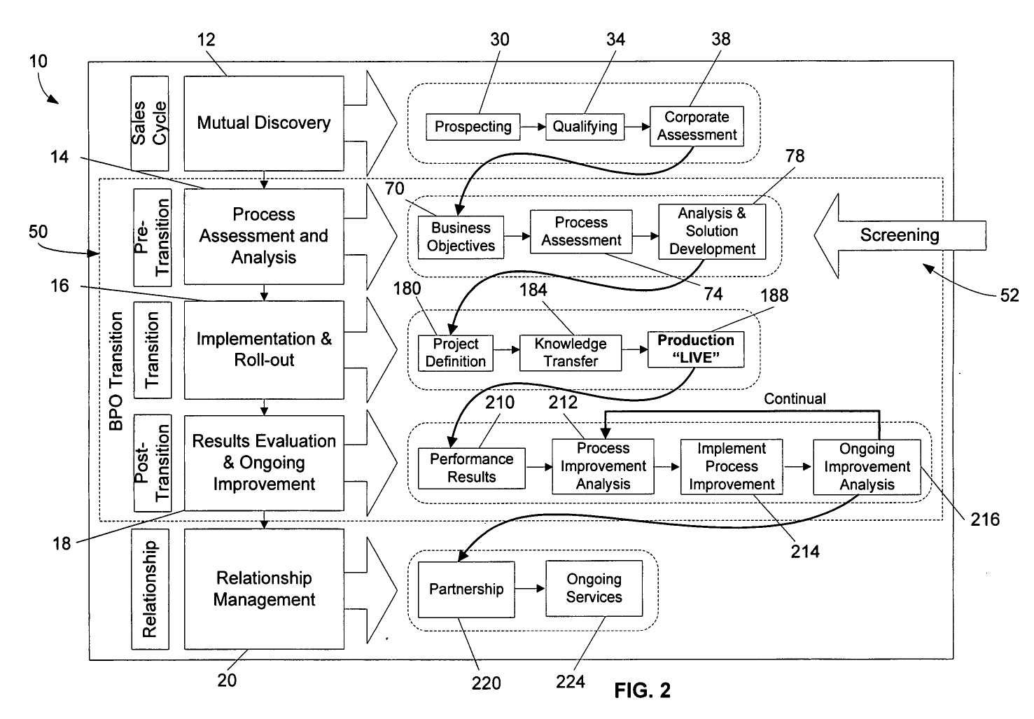

The method 10 can include a mutual discovery phase 12 that identifies a right or fitting partnerships between an owner of the business process (hereinafter “process owner”) and a potential outsourcing provider (hereinafter “outsourcer”). The method 10 can also include a process assessment and analysis phase 14 that provides a consultative approach to process evaluation and goal and objective setting. One activity for scoring a set of processes can take place during a process assessment step of the process assessment and analysis phase 14, as will be described below with respect to FIG. 2. The method 10 can further provide an implementation and roll-out phase 16 that prioritizes an action plan and aids the transfer of knowledge between a process owner and an outsourcer in order to execute a process transition. In addition, the method 10 can include a results evaluation and ongoing improvement phase 18 that records performance results after a process has been transitioned and continuously searches for areas of a transitioned process to refine and improve. Finally, the method 10 can include a relationship management phase 20 that establishes a continuing relationship between a process owner and an outsourcer after a process transition. In some embodiments, an engaged relationship executive and team can be established during the relationship management phase 20 in order to ensure continued success of a transitioned process.

Before the method 10 is described in detail, it should be understood that in addition to or in place of manually obtaining and processing data, portions of the method 10 can be performed by a computing system and/or a device that obtains information from one or more systems, databases, and/or human users, and analyzes, documents, validates, and/or routes data through the phases and steps of the method 10.

FIG. 2 illustrates various steps included in the phases of the method 10. As shown in FIG. 2, the mutual discovery phase 12 (also referred to a “sales cycle” phase) includes a prospecting step 30, a qualifying step 34, and a corporate assessment step 38. During the prospecting step 30, one or more process owners and one or more outsourcers can prospect or discover potential partnerships. For example, a process owner can identify outsource opportunities that are targeted to the specify industry and/or the focused processes of the process owner in order to established partnerships with an outsourcer that has specified experience related to the business of the process owner.

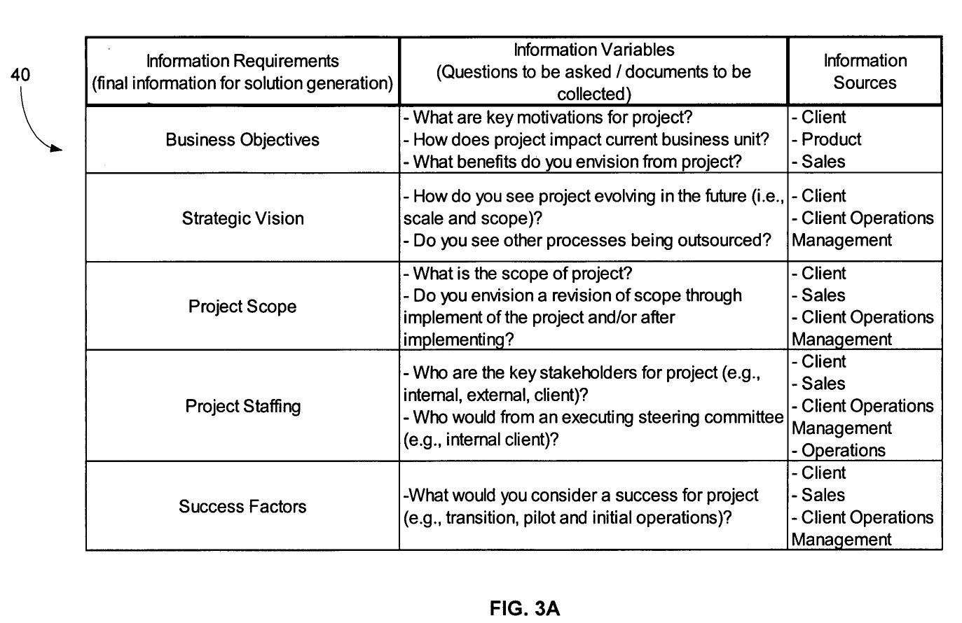

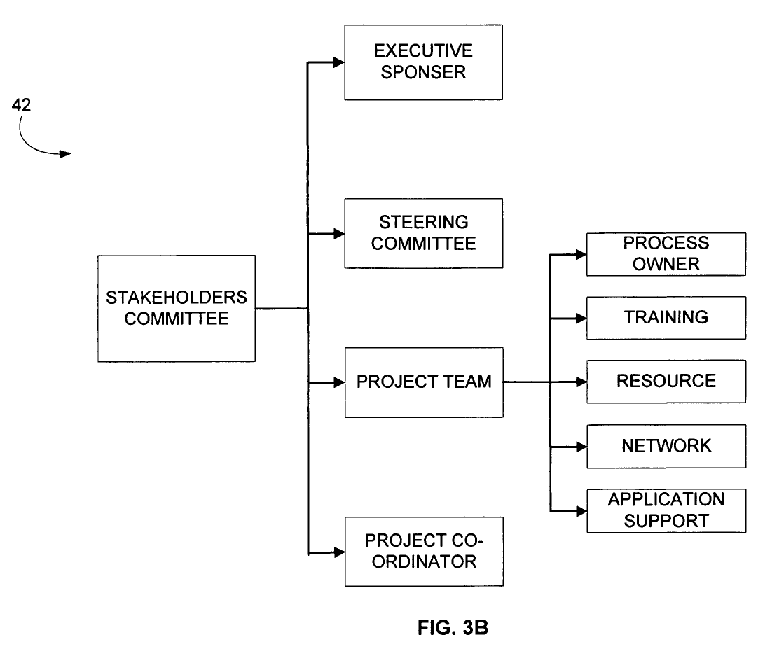

Once a potential partnership is identified, parties involved in the partnerships (i.e., a process owner and an outsourcer) can assess each other during the qualifying step 34 and the corporate assessment step 38 in order to determine whether each party is willing and/or capable of establishing a relationship. In some embodiments, a number of paper and/or electronic worksheets, checklists, diagrams, and process flow tools can be used in order to aid the steps of the mutual discovery phase 12. FIG. 3A illustrates a project checklist 40 that may be filled out when starting a BPO project. A project checklist 40 can identify individuals that should be consulted, knowledge that should be gathered, decisions that should be made, documents that should be collected, etc. in order to initiate a BPO project. In some embodiments, a project checklist 40 also helps identify a project team framework 42, as shown in FIG. 3B.

After completing the steps of the mutual discovery phase 12, the method 10 provides one or more steps that use a variety of tools in order to identify and transition one or more processes. As shown in FIG. 2, the method 10 includes a center or transition section 50, (the “BPO Transition” section) highlighting the steps involved in a process transaction. The transition section 50 includes the process and assessment and analysis phase 14, the implementation and roll-out phase 16, and the results evaluation and ongoing improvement phase 18.

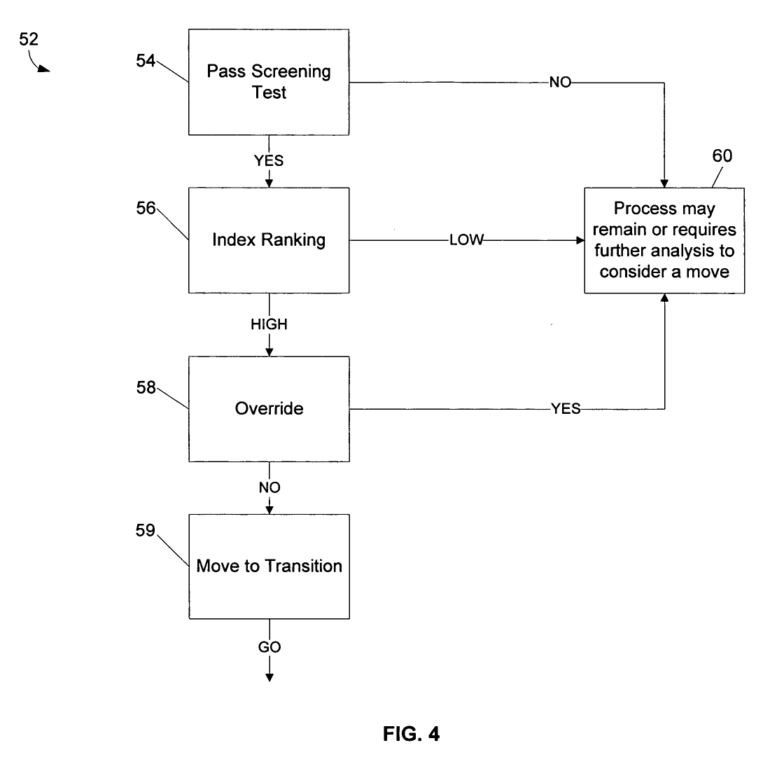

Proper planning, assessment and analysis before the transition may be the first step of a process transition. During the process assessment and analysis phase 14 (also referred to as the “Pre-Transition” phase), a process “screening” method 52 can be used to rule out processes that are not suitable for outsourcing. In some embodiments, the screening method 52 allows both parties to focus on the processes that are most likely to fit ideal outsourcing characteristics. As shown in FIG. 4, the screening method 52 can include multiple considerations, such as a screening test step 54, an index ranking step 56, an override consideration 58, a move to transition step 59, and a further analysis step 60. The screening method 52 can help separate a group of processes into two buckets—processes that could be outsourced and processes that should be retained. To separate a group of processes, various characteristics of proposed processes can be screened against a set of standard criteria employed in the early stages of the screening method 52. Typical characteristics considered in the screening method 52 can include the following: does a targeted outsourcer have domain knowledge; is a process a targeted process (was it identified to be outsourced); does a process meet minimum volume thresholds; is a process a standardized, repeatable or rules-based process; can a process be unbundled; etc.

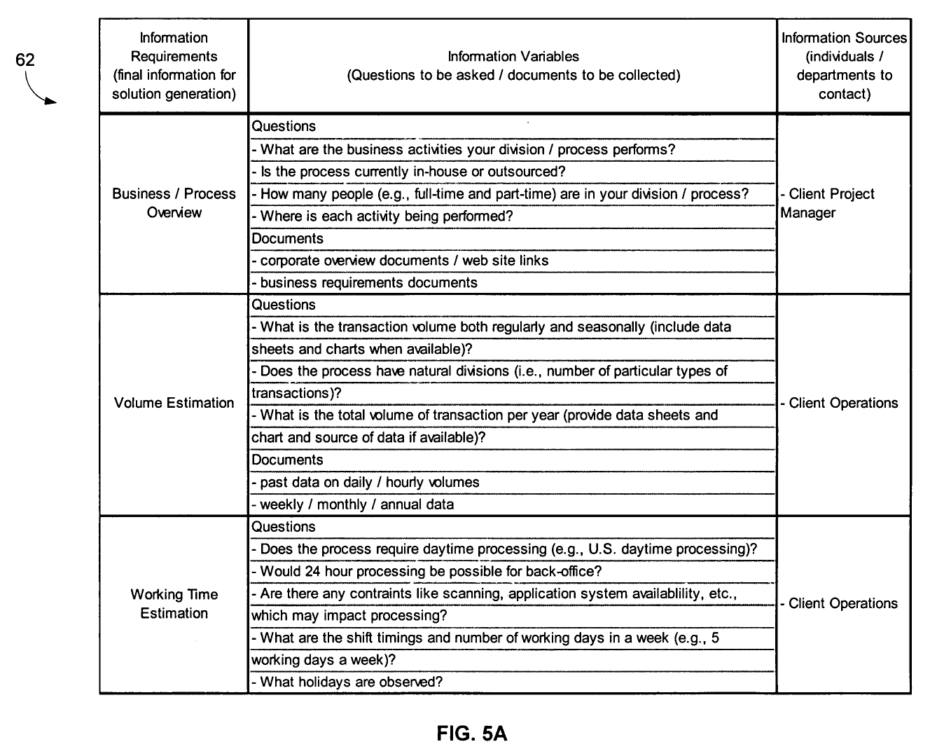

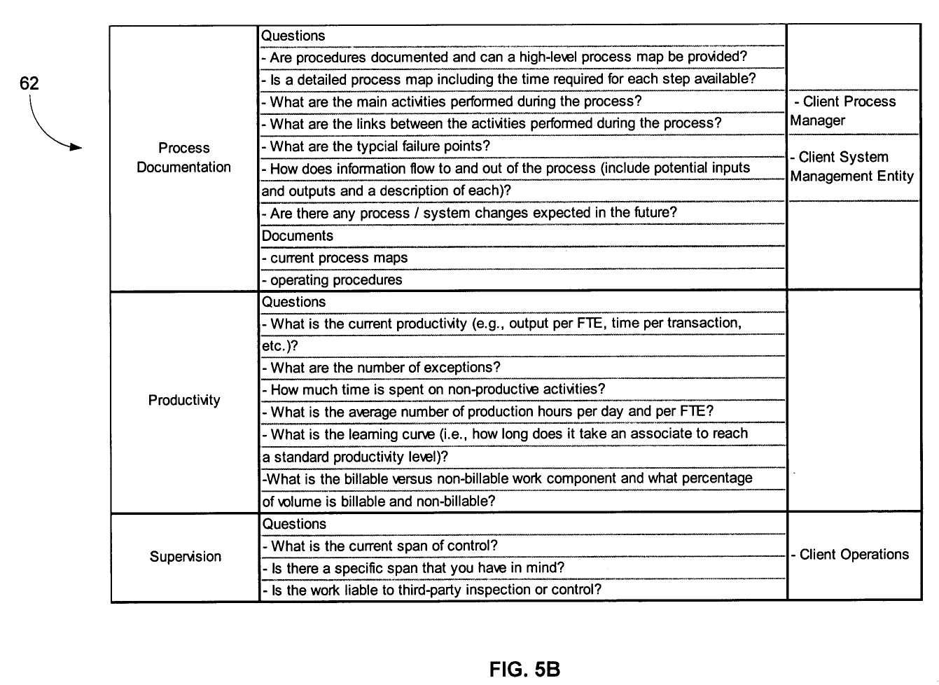

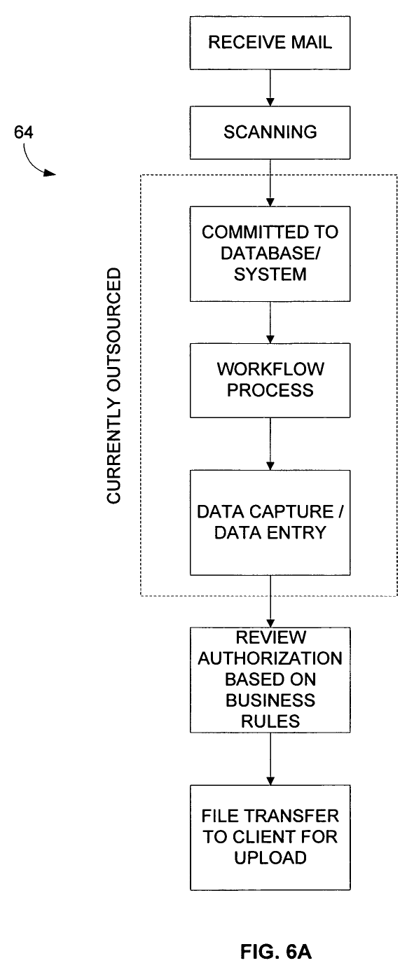

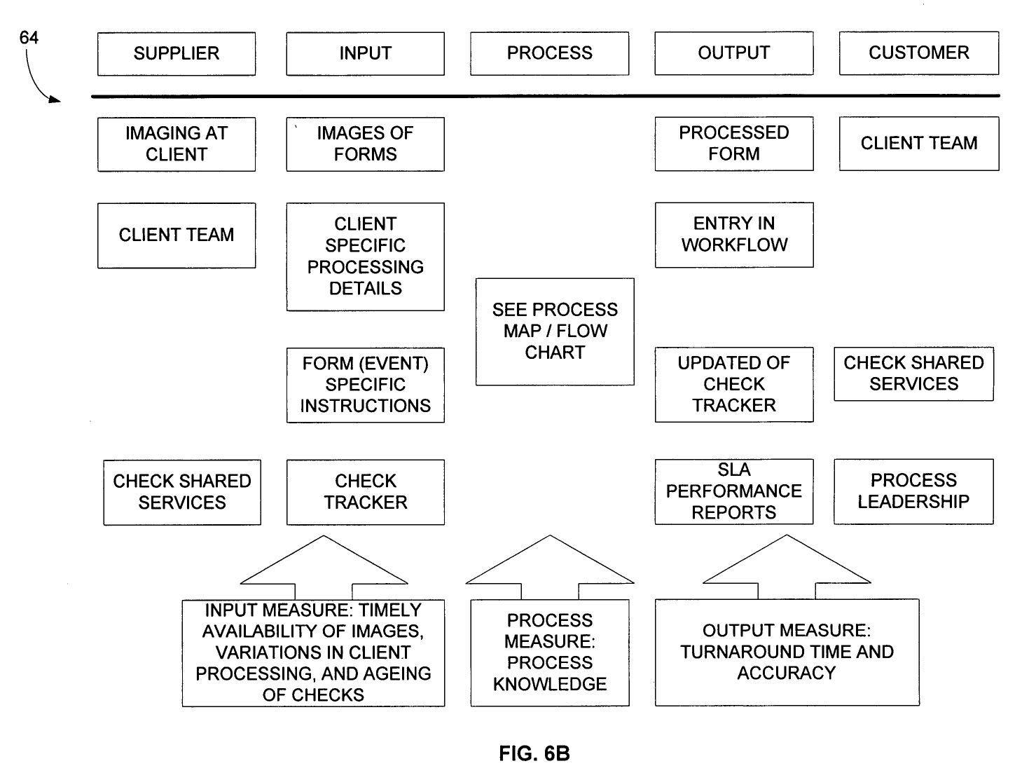

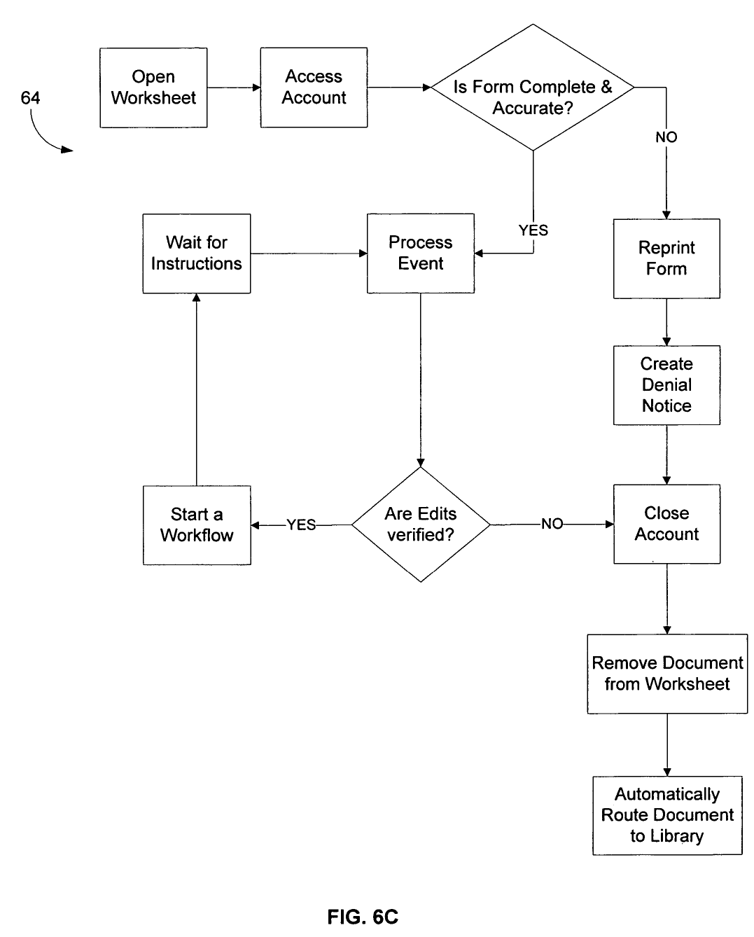

As shown in FIG. 4, the screening method 52 begins at the pass screen test step 54. In some embodiments, a process checklist 62, portions of which are shown in FIGS. 5A and 5B, may be used during the pass screen test step 54. A process checklist 62 can be completed for each process included in the screening method 52 in order to capture as much data as possible concerning a particular business process. A process checklist 62 can serve as an initial evaluation to eliminate processes not suited for outsourcing before considerable time and money is spent. In some embodiments, one or more the process diagrams 64, which graphically describe a processes, are also used in combination with or in place of the process checklist 62. A process diagram 64 can include one or more preexisting or newly-created process flow charts, maps, hand-off diagrams, and/or supplier-input-process-output-customer (“SIPOC”) diagrams. FIGS. 6A-6C illustrate examples of process diagrams 64 that can be used to screen and evaluate a process.

If a process does not pass an initial screening test during the pass screening test step 54, a process outsourcing decision may be moved to the further analysis step 60. At the further analysis step 60, a decision can be made whether to keep a process in-house or further analyze a process before a decision is made regarding the outsourcing potential of a process.

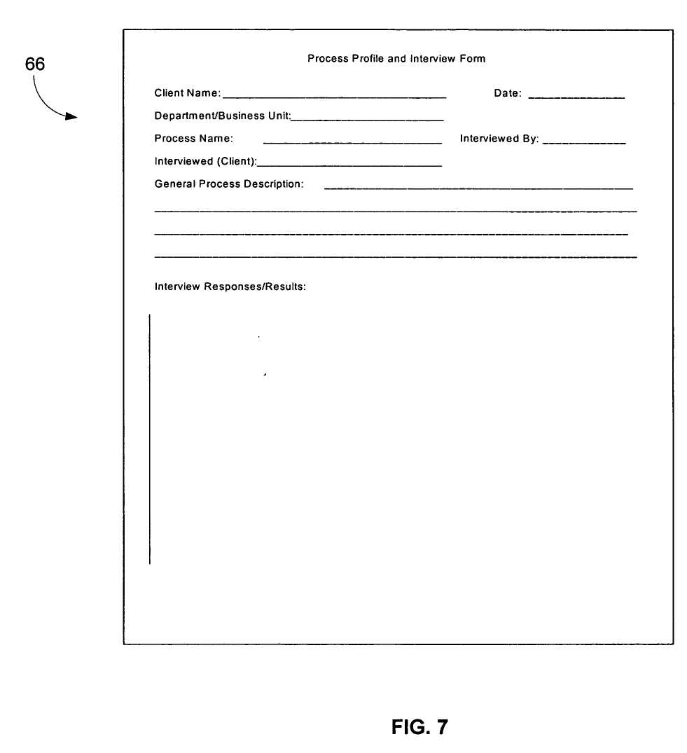

As part of the pass screening test step 54 and/or in preparation of the index ranking step 56, business processes that were not eliminated in the preliminary inspection may be evaluated more rigorously. In some embodiments, a process profile and interview form 66, as shown in FIG. 7, may be used as a roadmap for a detailed process evaluation.

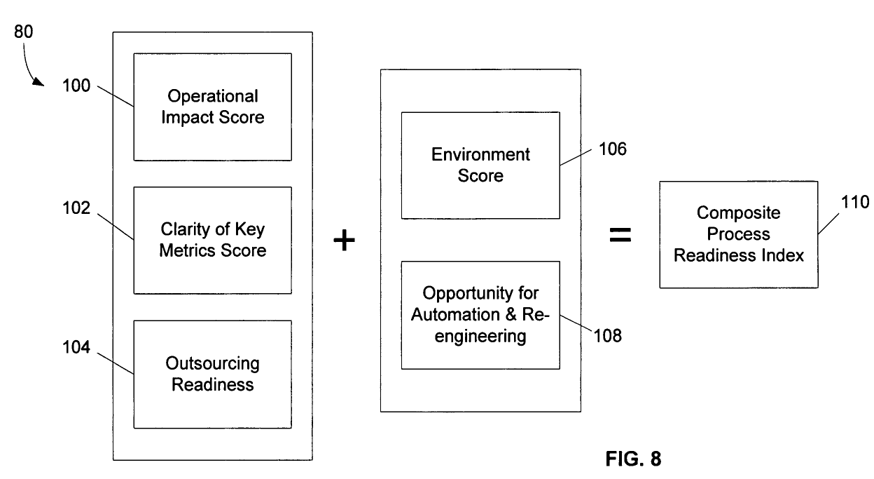

After the pass screening test step 54, processes that passed the initial screen test can move to an index ranking step 56. During the index ranking step 56, process characteristics can be obtained and used to establish a process readiness index (“PRI”) that specifies the readiness of a process to be outsourced. Determining a PRI is described in detail below with respect to FIGS. 8-14.

After completing the index ranking step 56, one or both parties involved in a potential BPO project can use the PRI for each potential process in order to determine and/or identify one or more processes that are suitable for outsourcing. In some embodiments, one or more both parties can establish an optimal threshold or range, and any process whose PRI falls over the threshold or within the optimal range are considered candidates for outsourcing. Likewise, any process whose PRI falls below the optimal threshold or outside the optimal range can move to the further analysis step 60.

After the index ranking step 56, the screening method 52 can apply the override step 58 in order to determine if any circumstances exist, which were not considered in the pass screening test step 54 and/or the index ranking step 56, that would restrict or hinder the outsourcing of an identified candidate process. Overridden candidate processes can remain as in-house processes and/or can receive further analysis in order to justify and/or determine the potential and profitably of outsourcing the processes (step 60 of FIG. 4).

As shown in FIG. 4, if a process passes the initial screening test step 54, the index ranking step 56, and the override step 58, the process can be identified as being ready for transition to an outsourcer (step 59).

As shown in FIG. 2, the screening method 52 can be included as part of the process assessment and analysis phase 14. The process assessment and analysis phase 14 can include a business objectives step 70, a process assessment step 74, and an analysis and solution development step 78. During the business objectives step 70 both parties can define business imperatives that are trying to be solved through process outsourcing. For example, one or both parties can define goals and provide a relative importance and a desired end result of each of their goals. In some embodiments, executive interviews, senior management interviews, divisional or operating unit interviews, and/or outsourcing executive interviews can be conducted in order to obtain business imperatives. During interviews and/or separate from interviews, questionnaires can be distributed that can be used to help provide a corporate overview and/or review business process assessment. A project checklist 40, as shown in FIG. 3A, can also be used in order to obtain business objectives.

At the end of the business objectives step 70, one or both parties can have an understanding of executive goals and objectives, as well as a broad view of a business environment surrounding a BPO project. In addition, the results of the business objectives step 70 can include establishing a roadmap for transaction assessment that can be used throughout the method 10.

After the business objectives step 70, the process assessment step 74 can be performed in order to facilitate process selection and confirm process readiness for outsourcing. In some embodiments, process selection and outsourcing readiness can be based on the assessment of the organization of a process owner, an outsourcer, and/or a processes. Process selection and outsourcing readiness can also be based on documentation and/or metrics available for one or more processes of the process owner. To accomplish process assessment, in-depth process reviews can be conducted with a process owner (either on-site or off-site) in order to obtain initial knowledge regarding a process, evaluate a process, and benchmark a process. In some embodiments, information obtained during a process review can be used to calculate a PRI. In some embodiments, people, process, and project checklists, portfolio reviews, business process reviews, performance metrics, technology assessments, financial impacts, and risk assessments can also be used to a obtain process characteristics that can be used to determine or calculate a PRI.

Calculating a PRI can be a tool that can be used before proceeding with recommendations for processes to outsource. The PRI can be used to evaluate each process in greater detail, and calculating a PRI for each process can help sequence processes by order of importance and/or urgency for transition. Some processes may be overridden by a client and may be manually selected to be transitioned or to remain in-house regardless of a PRI associated with a process and/or other process evaluation results. This override determination would typically occur after a PRI calculation has been determined for a process.

In some embodiments, PRI calculations are designed to rank order processes for “outsourceability.” PRI determination can include an algorithm or formula 80, an example of which is shown in FIG. 8, that provides an analytic approach to solving complex questions and produces an evaluation of a set of potential processes to outsource.

In some embodiments, a PRI algorithm 80 includes a number of predictive process characteristics (e.g., 18) that are summarized into a number of characteristic groups (e.g., 5). For example, process characteristics can be grouped in an operational impact group 82, a clarity of key metrics group 84 (also referred to as a strategic drivers group), an outsourcing readiness group 86, an environmental group 88, and an opportunity for automation and re-engineering group 90. Each characteristic included in a characteristic group can receive a numeric score, which in turn is weighted accordingly based upon a weighting associated with the characteristic group to which the characteristic belongs (e.g., an characteristic included in an operational impact group receive a 40% weighting). With weighted scores computed for each characteristic group, the algorithm 80 can then generate a PRI ranging from 1 to 100. As shown in FIG. 8, the algorithm 80 can include determining an operational impact group score 100, a clarity of key metrics group score 102, an outsourcing readiness score 104, an environmental score 106, an opportunity for automation and re-engineering score 108, and a composite process readiness score 110 that represents a PRI. In some embodiments, the composite process readiness score 110 can include the sum of the operational impact score 100, the clarity of key metrics score 102, the outsourcing readiness score 104, the environmental score 106, and the opportunity for automation and re-engineering score 108.

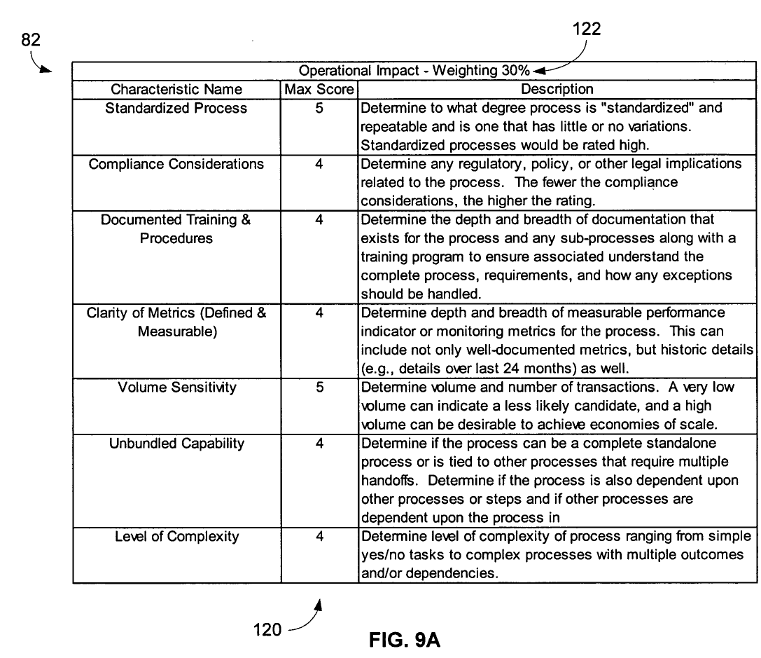

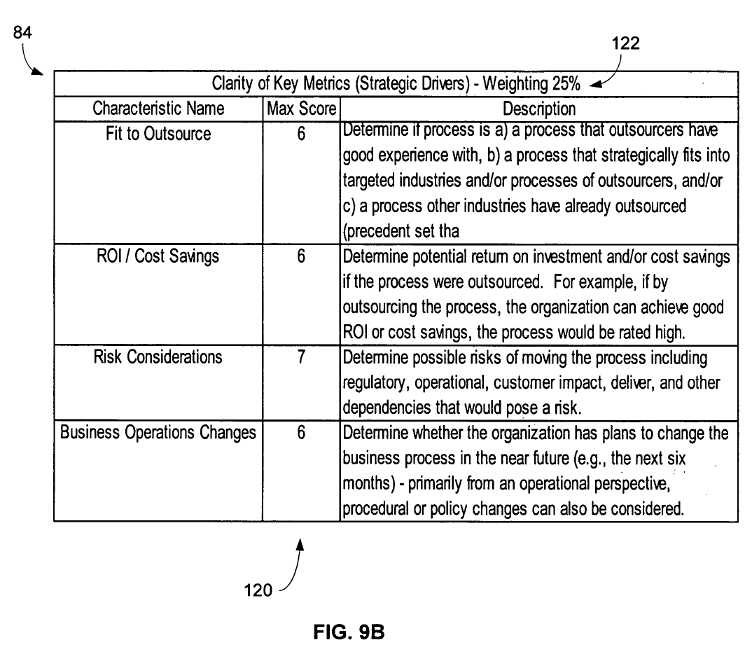

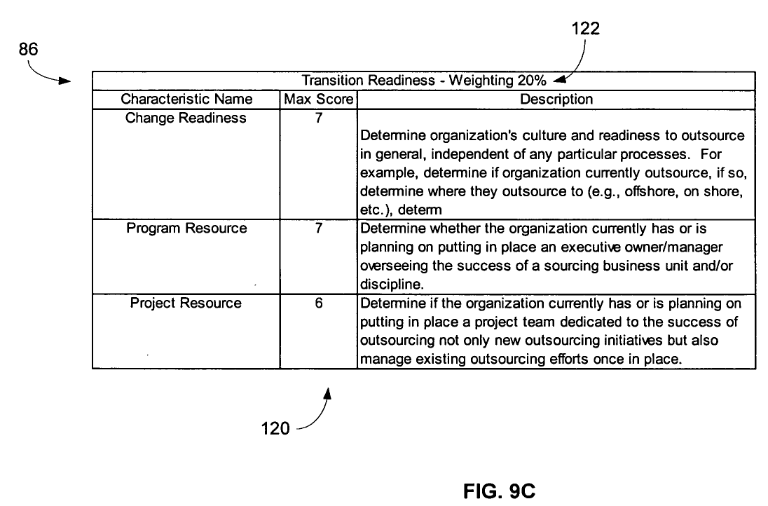

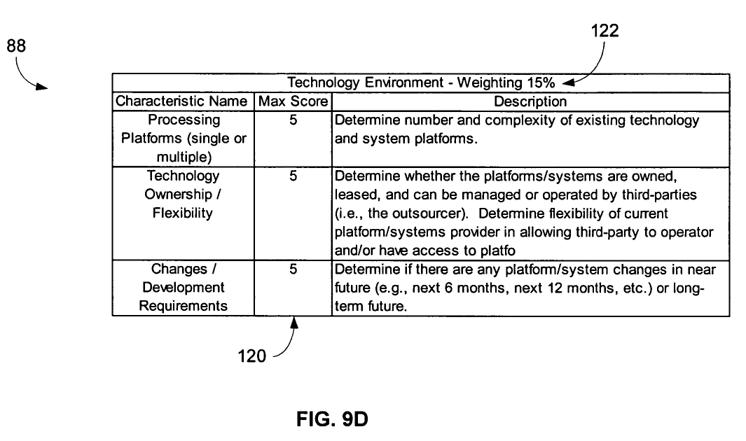

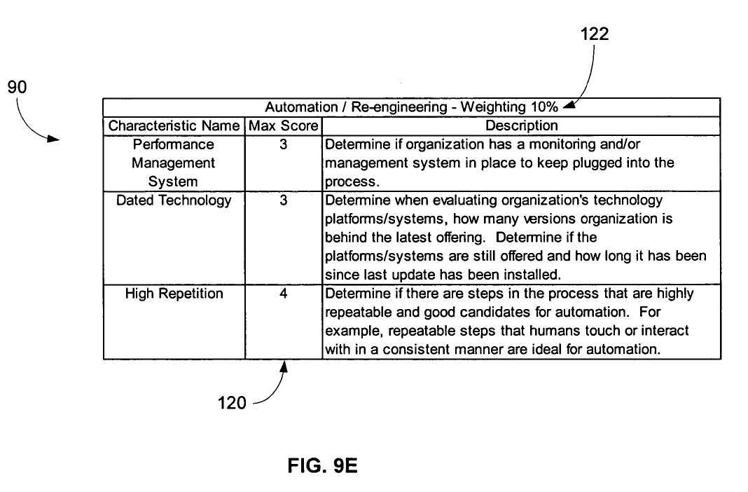

As described above, each characteristic group can include one or more process characteristics. In some embodiments, each characteristic group can include process characteristics that have similar attributes and/or are associated with similar aspects of a process. For example, Technology Factors is a group classification that is comprised of characteristics related to systems, technology, and infrastructure the may be needed to support a process. FIGS. 9A-9E describe five characteristic groups in greater detail according to one embodiment of the invention. Each characteristic group can include one or more process characteristics (a brief description of which is shown in FIGS. 9A-9E). Each process characteristic included in a characteristic group can have a maximum attainable score 120. Each characteristic group also can have a weighting 122 assigned. A score for a particular characteristic group can be determined by summing the scores for each of the process characteristics (ranging from 1 to the maximum attainable score 120) included in the characteristic group and multiplying the score by the weighting 122.

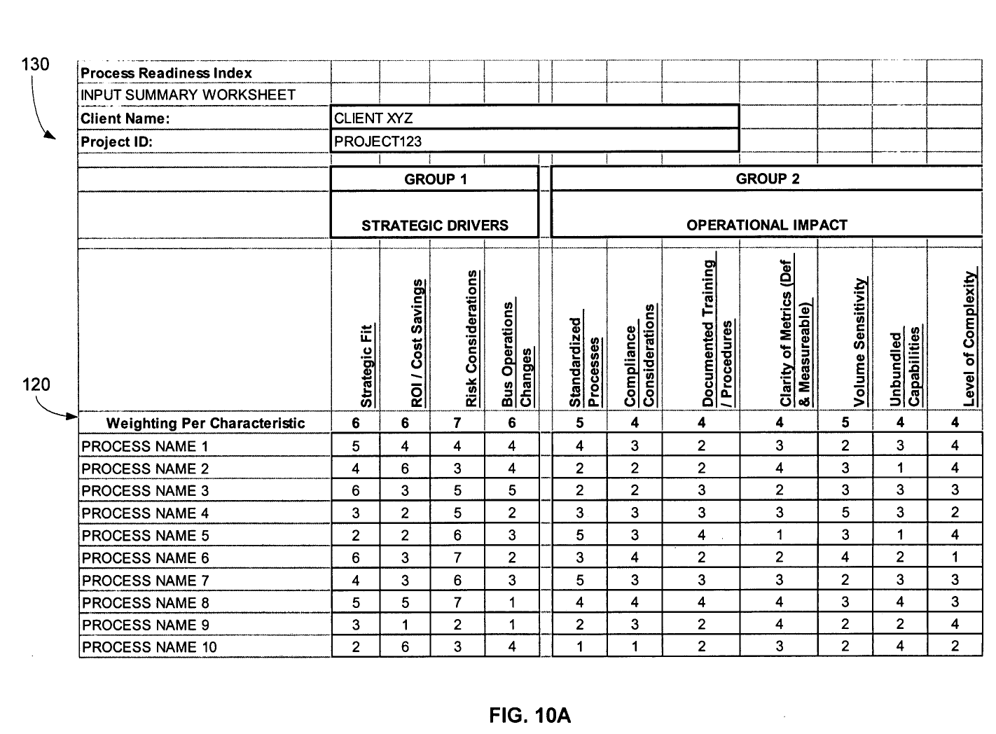

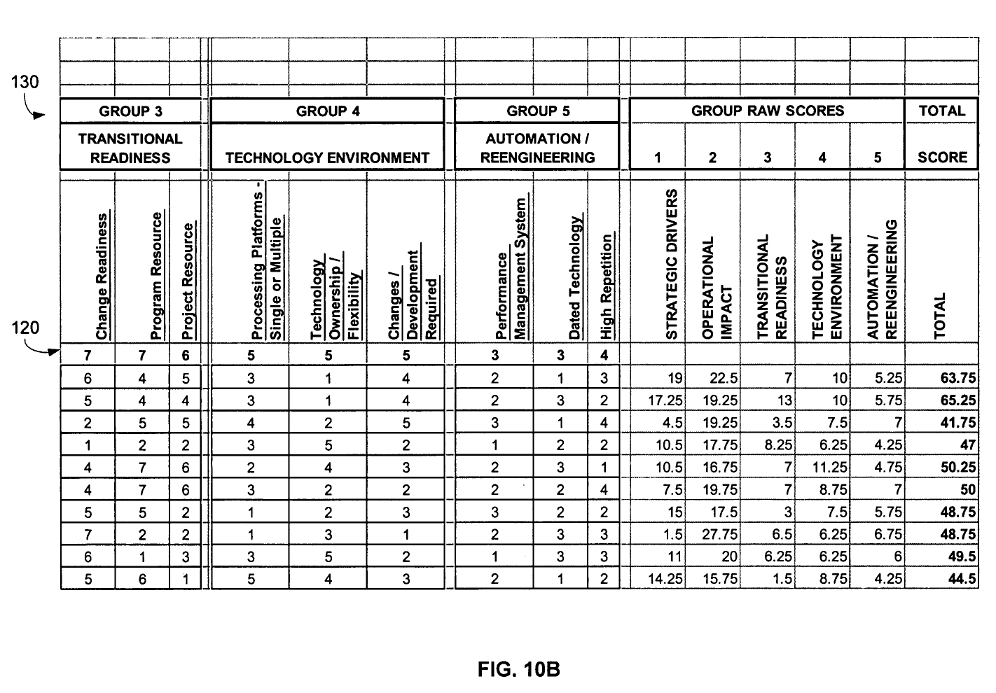

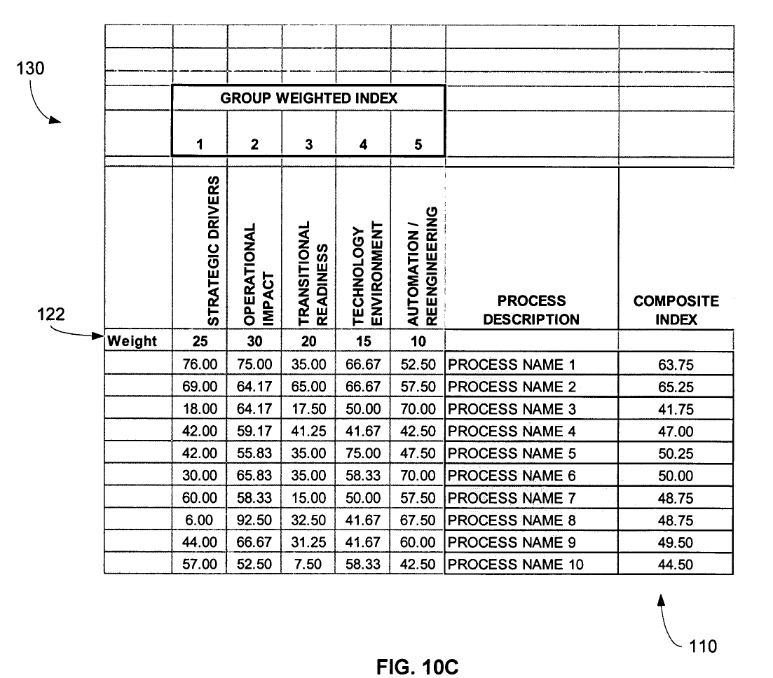

In some embodiments, a PRI input worksheet can be used to determine a PRI for one or more processes based on the process characteristics and the PRI algorithm 80, as described with respect to FIG. 8. For example, each process can be evaluated based on process characteristic associated with one or more characteristics groups, such as the five characteristic groups described with respect to FIGS. 9A-9E. Portions of a PRI input worksheet 130 according to one embodiment of the invention are shown in FIGS. 10A-10C.

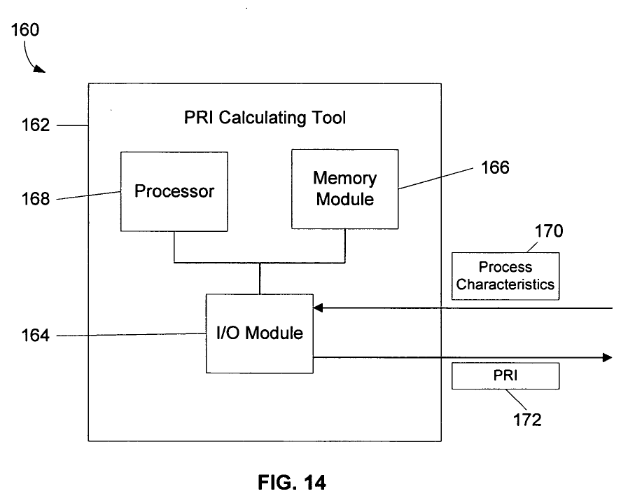

The PRI input worksheet 130 may be in an electronic form, such as a computerized spreadsheet created with Microsoft® Excel or a similar application, that allows information to be quickly inputted, viewed, changed, and organized. The PRI input worksheet 130 may also be implemented as an input screen displayed as a user interface of a PRI calculating tool (described with respect to FIG. 14).

Process characteristic scores or ratings for one or more processes can be input into the PRI input worksheet 130. As shown in FIGS. 10A-10C, the PRI input worksheet 130 lists each process by a unique name. For each process evaluated, each process characteristic within one or more characteristic groups is assigned a score. In some embodiments, the score for each process characteristic ranges from 1 to a maximum attainable score 120, with 1 being the lowest score and the maximum attainable score 120 being the highest. Process characteristics can be evaluated relative to other processes managed either by the process owner and/or outsourcer performing the BPO project or managed by other organizations. In some embodiments, by comparing a process to outsourced processes managed by other organizations, a process can receive a more accurate rating. For example, if a process owner has very limited data for most of the processes it manages, but has limited or inaccurate data for one process, that process should not receive a high score solely because it has a larger amount of data than the other processes managed by the process owner.

In some embodiments, each score is based on information provided for a particular process during a process interview. In some situations, an amount of quantifiable data may be used to determine a score. For example, if 24 months of historic detailed performance data is available for a process, it should be rated a high score as having well-documented performance data. On the other hand, if another process reviewed yields only 6 months of limited metrics, this would likely be rated a lower score. In this example, a similar process would be rated one of the lowest scores if there is little to no historic information, and/or the majority of the processes did not have adequate metrics reported.

For example, when using a valid score range of 1 to a maximum attainable score 120, a score of 1 can be assigned when little or no information is available for the process or when there has been little consideration for this characteristic. In general, a process with no metrics or key performance indicators (“KPIs”) or no volume data may receive a score of 1. Scores between 1 and the maximum attainable score 120 can be used to indicate that some information is available but not enough relative to other processes. For example, a score of 2 between a score range of 1 and a maximum attainable score 120 of 4 indicates a lower rating that can be used if some information is available but not enough relative to other processes for it to be considered. A score of 3 within the same range can represent a higher rating used when there is more information available than a similar score of 2, but not enough to assign a 4 rating. A score of 4 (or the maximum attainable score 120) can be the highest rating a process characteristic can attain and can be used when all of the necessary information is available or for a process characteristic, such as risk considerations where a score of 4 can represent that the process has little or no risks associated with it. It should be understood that other scales can also be used.

Once individual scores are recorded for process characteristics included in one or more characteristics groups, a sum of the scores of the process characteristics included in a particular characteristic group can be determined and weighted by the weighting 122 associated with the particular characteristic group, as shown in FIGS. 9A-9E. A composite process readiness score 110 can then be determined for a particular process by summing the weighted sums of the characteristics groups for a particular process. The composite process readiness score 110 can represent the PRI for the process.

In some embodiments, information used to determine a PRI can be verified for quality assurance. One or more reports, such as including graphical output, can also be produced based on the PRI information. If the process characteristics scores are input into a computer application or electronic spreadsheet, the PRI calculations and the resulting reports can be programmed or coded into the spreadsheet and automatically generated. In some embodiments, after filling out the PRI input worksheet 130 and quality checking the entered data, one or more PRI summary reports 140 and individual PRI reports 150 may be generated based on the data.

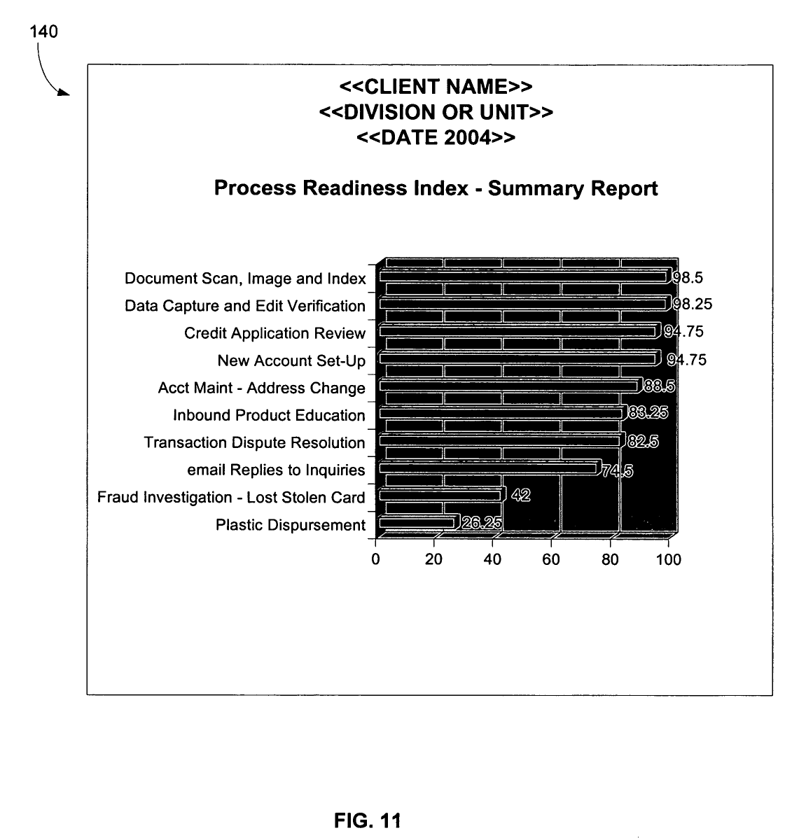

FIG. 11 illustrates a PRI summary report 140 according to one embodiment of the invention. A PRI summary report 140 can include a summarization of each of the processes, and, in some embodiments, provides a graphical representation of a ranking of the evaluated processes based on each process's PRI. In some embodiments, the PRI summary report 140 illustrates the evaluated processes sorted in a descending order from highest PRI to lowest PRI. As shown in FIG. 11, the PRI summary report 140 can display process names along the y-axis of a graphical representation of a process ranking and composite PRI scores along the x-axis of the graphical representation.

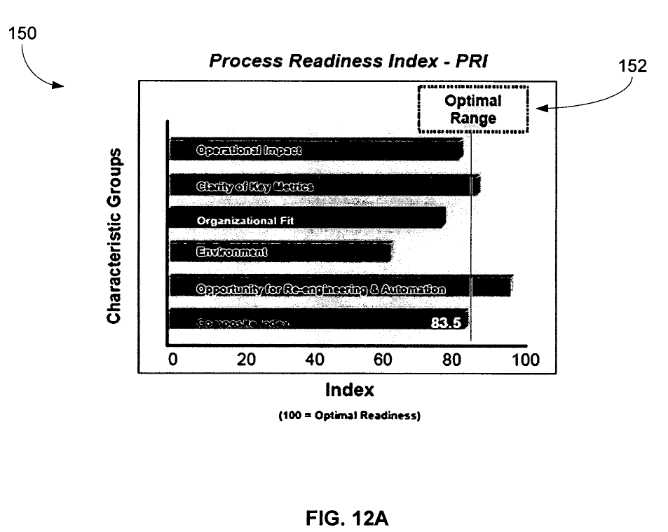

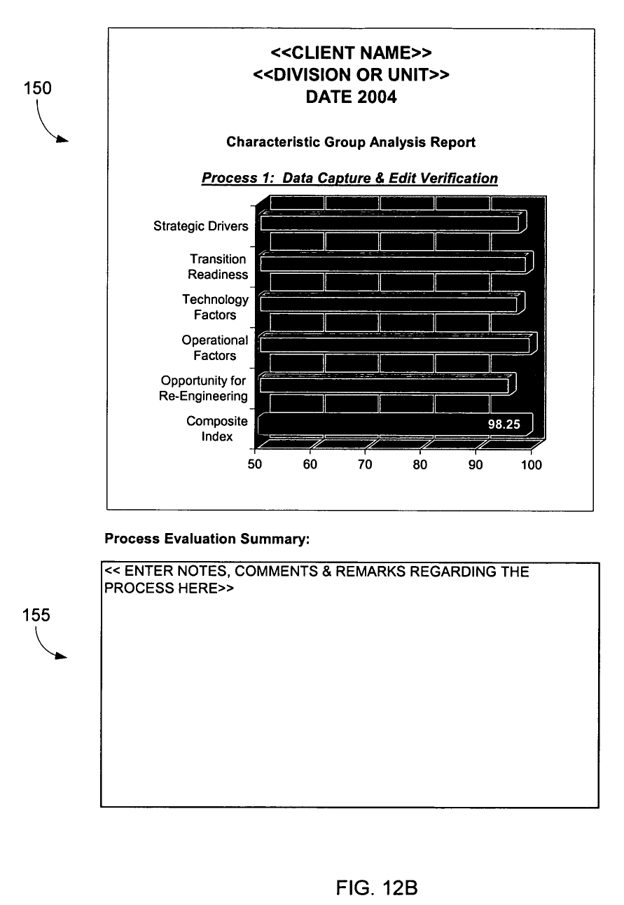

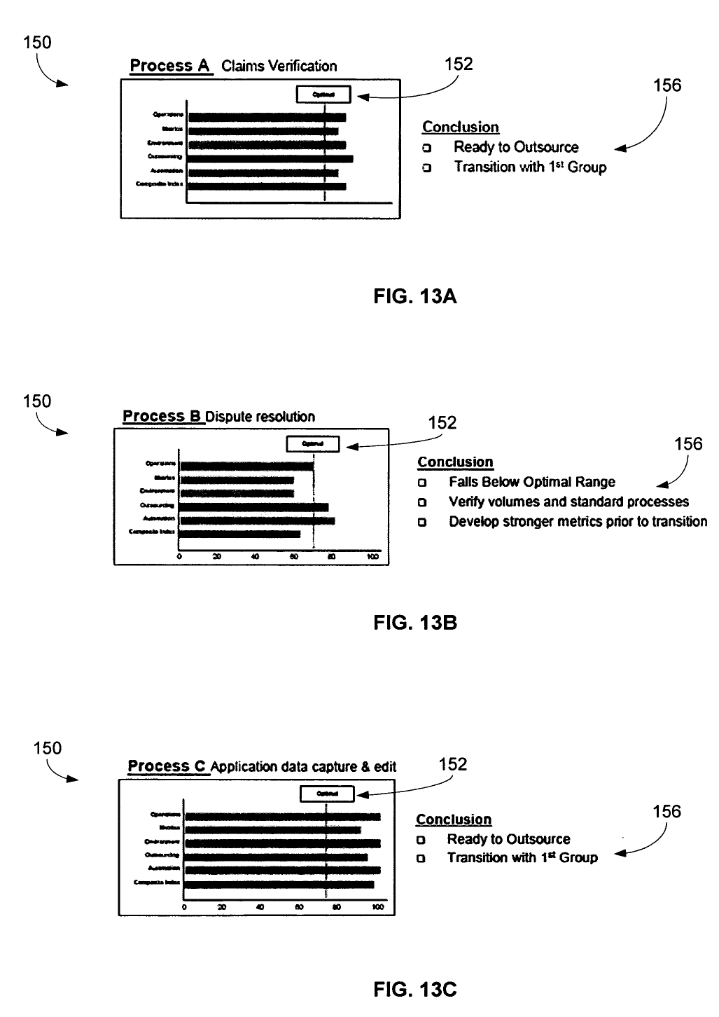

FIGS. 12A, 12B, and 13A-13C illustrate examples of PRI individual reports 150. A PRI individual report 150 can provides a view of individual characteristic group scores for a particular process in order to reveal the characteristic group information for a process. As shown in FIGS. 12A, 12B, and 13A-C, a PRI individual report 150 provides a summary view of each of five characteristic groups of the algorithm 80 for a particular process. Each report 150 can also include a composite process readiness score 110 for a particular process and/or an optimal range indication 152 that indicates an optimal range or threshold, where any scores within the optimal range or above the optimal threshold can be considered scores indicating an optimal outsoureability score.

In some embodiments, a PRI summary report 140 and/or a PRI individual report 150 includes a comment section 155 for comments regarding reasons for particular scores or aspects of a process that are not indicated by the PRI, or aspects of a process that are subject to change. FIG. 12B illustrates a PRI individual report 150 that includes a comment section 155 according to one embodiment of the invention.

A PRI summary report 140 and/or a PRI individual report 150 can also include a conclusion section 156. A conclusion section 156 can include recommendations and/or decisions made based on the information presented in a report. FIGS. 13A-13C illustrate examples of PRI individual reports 150 including a conclusion section 156 for three unique processes that were evaluated by determining a PRI. It should be understood that the conclusion section 156 can be automatically generated by a system or application that generates the reports and/or can be populated with human input.

It should be understood that the PRI summary report 140 and the PRI individual reports 150 as described and illustrated above are examples or reports that can be generated based on the determination of one or more PRIs. A process owner and/or outsourcer can generate custom and/or tailored reports as needed in addition or in place of the above-described reports.

Using one or more summary reports 140 and/or individual reports 150, a process analyst can review the PRI information and create initial recommendations. The recommendations can point out obvious processes that should/could be outsourced, processes that perhaps need more information to be considered further, and processes that may not be good candidates for outsourcing. This grouping into three groups may be a starting point for further detailed discussion about a formalized proposal for one or more process transitions and/or outsourcing engagements.

The information presented in the reports 140 and 150 (and/or the recommendations provided by a process analyst) can also allow an executive team of the process owner to view a rank ordering of processes and make well-informed decisions about which processes should be considered immediately, which processes that may not make good outsourcing sense, and which processes are good candidates but may be considered in a subsequent transition phase.

In general, the data provided by a PRIs and/or PRI rankings can offer many insights. For example, a PRI ranking can help create a roadmap with all processes rank ordered for a big picture view; can provide continuity and linkage across processes for “candidate” groups of processes; can pinpoint possible gap areas and confirm ideal processes for transition; can make a go/no-go decision; and can prioritize each process for readiness. Breaking the composite score into a number of characteristic groups, as shown in an individual PRI report 150 (FIGS. 12A-13C), also allows a more detailed view into the data and reasons driving the ranking of particular processes. PRIs and/or PRI rankings can also provide other beneficial information unrelated to BPO projects, such as a process that may be improved through standardization, improved performance tracking, more thorough documentation, etc.

PRIs and/or PRI rankings can be used to evaluate processes ready for outsourcing in order to complete situation analysis and can be used to identify improvements to processes and systems for consulting purposes. In some embodiments, one of the main purposes of the PRI is to rank order processes in order to recognize one or more candidate processes to transition or outsource, and perhaps specify an order and/or a priority for transitioning processes if multiple processes are identified. Given this goal, there may be no predefined “cutoff” score threshold; however, in some embodiments, a PRI score below 60 may be evaluated more closely in order to understand specific reasons for the low score. For example, a process may not have been documented or documented adequately and/or may not have any KPIs available, and, therefore, the process would likely receive a lower score. This may not mean the process is not a good candidate for outsourcing, but may require a full documentation and analysis of the process in order to create historic performance metrics. After proper data has been collected, the process may be reconsidered for transition.

PRIs and/or PRI rankings can also provide a technical assessment evaluation and can help develop a high-level BPO project plan that provide scope definition for transiting a process, not transitioning a process, prioritizing the transitioning of one or more processes, etc.

As described with respect to FIG. 1, portions of the method 10, such as the process assessment step 74, can be performed by a computing system and/or device that obtains information from one or more systems, databases, and/or human users, and analyzes, documents, validates, and/or routes data through the phases and steps of the method 10. For example, a computing system 160, as shown in FIG. 14, can be used to enter process characteristics, determine one or more PRIs, and generate output, such as one or more reports, based on the PRIs and/or the PRI rankings. The computing system 160 can include a PRI calculating tool 162. The PRI calculating tool 162 can include an input/output (“I/O”) module 164, one or more processors (“processor”) 168, and a memory module 166. The I/O module 164 can be configured to receive process characteristics 170 from one or more sources, such as other systems, applications, data repositories, and/or human input. In some embodiments, the I/O module 164 can provide a user interface on a display or screen (not shown) that prompts a user to enter the process characteristics 170.

After obtaining the process characteristics 170, the I/O module 164 can transmit the process characteristics 170 to the processor 168. The process characteristics 170 can include process characteristics for one or more business processes. In some embodiments, the I/O module 164 can transmit the process characteristics 170 to the memory module 166 in addition to or in place of transmitting the process characteristics 170 to the processor 168, and the processor 168 can retrieve the process characteristics 170 from the memory module 166. The memory module 166 can include computer readable medium that stores software (“instructions”) that the processor 168 can obtain and execute in order to determine a PRI 172 based on the process characteristics 170.

As described above, the processor 168 can execute software in order to group the process characteristics into one or more characteristic groups. For example, the processor 168 can group the process characteristics 170 into one of five characteristics including an operationally impact group 82 (as shown in FIG. 9A), a clarity of key metrics group 84 (as shown in FIG. 9B), an outsourcing readiness group 86 (as shown in FIG. 9C), an environmental group 88 (as shown in FIG. 9D), and an opportunity for automation and re-engineering group 90 (as shown in FIG. 9E). In some embodiments, the process characteristics 170 can be received already grouped into a particular characteristic group (e.g., by another system or application from which the process characteristics 170 were obtained or by the I/O module 166).

In some embodiments, the processor 168 can also validate the process characteristics 170. The processor 168 can validate the process characteristics by ensuring that each process characteristic is within an acceptable range. For example, in one embodiment, the processor 168 can ensure that each a score associated with each process characteristic includes a numeric value between one and a maximum attainable score 120. A maximum attainable score 120 for a particular process characteristic can be preprogrammed into the processor 168 and/or the memory module 166 and/or can be included as part of the process characteristics 170.

After grouping the process characteristics 170, the processor 168 can generate a sum of the process characteristics associated with each characteristic group for each process associated with the process characteristics. The processor 168 can then generate a weighted sum of each sum of each characteristic group based on a weighting 122 (as shown in FIG. 10C) associated with each characteristic group. A weighting 122 for a particular characteristic group can be preprogrammed into the processor 168 and/or the memory module 166 and/or can be included as part of the process characteristics 170.

Using the weighted sums, the processor 168 can determine a composite process readiness score (i.e., a PRI 172) for each process by summing the weighted sums of each characteristic group for each process. After determining a PRI 172 for one or more processes, the processor 168 can store the PRIs 172 to the memory module 166 and/or can transmit the PRIs 172 to the I/O module 164. The I/O module 164 can output the PR's 172 to one or more external systems, applications, data repositories, user interfaces, etc.

In some embodiments, the processor 168 and/or the I/O module 164 can be configured to generate one or more reports, such as a PRI summary report 140 and/or a PRI individual report 150 as described with respect to FIGS. 11-13C, based on the PRIs 172, and the I/O module 164 can be configured to output the reports to an external system, application, data repository, and/or a display device, such as a monitor, a printing device, etc., for storage, output, and/or display on a user interface.

As noted, identifying business processes ready and able for outsourcing is only the first step of actually outsourcing business processes. Completing the process assessment step 74 shown in FIG. 2 can mark the beginning for a successful outsourcing engagement. As shown in FIG. 2, the process assessment and analysis phase 14 also includes the analysis and solution development step 78. During the analysis and solution development step 78, selected processes can be compared against internal and external context and goals. In addition, the implications of outsourcing selected processes can be evaluated in order to be fully understood and to establish linkages for people, processes, technology, implementation, and change management. In some embodiments, PRIs and/or PRI reports, project management tools, project plans, project scope definitions, project team structures, project deliverables and associated timeframes, resource allocations, and regulatory input reviews can be used as tools and/or methods for evaluating selected or candidate processes. Further evaluating the selected processes can help develop a sound operation and execution plan framework and can establish a high-level BPO project plan, an operational solution plan, a commercial proposal, a technology solution recommendation, and/or a meeting and/or an establishing of a regulatory compliance requirement associated with a process transition.

After the initial mutual discovery phase 12 and the process assessment and analysis phase 14, a business process outsourcing transition engagement or agreement can be established for a particular business process identified as a good candidate for outsourcing. An outsourcer and/or a process owner, however, can go through a number of phases before a process is transitioned and successfully operating.

After processes have been identified for outsourcing, some embodiments of the invention may aid the construction of transition plans and post-transition plans for an entire lifecycle of a BPO project. As shown in FIG. 2, the implementation and roll-out phase 16 (also referred to as the “Transition” phase) includes a project definition step 180, a knowledge transfer step 184, and a production or implementation roll out step 188. An objective of the project definition step 180 can include establishing a detailed transition and change management project that outlines mitigation factors. In some embodiments, project plans, process documentation, transition and change management documentation, roles and responsibility matrices, and agreements, such as service level agreements (“SLAs”), can be used to validate processes, document processes, review project scope, and establish measurable transition objectives. After the project definition step 180 parties involved in the transition can have a completed scope document, which can be used to further understand the responsibilities and the requirements for undertaking a transition. In particular, during the project definition step 180 and in order to plan for a process transition, parties can develop a detailed-level BPO project plan, a weekly milestone review plan, one or more measurable objectives, a communication plan, a risk management plan, an issues log, one or more master services agreements, one or more SLAs and/or statements of work (“SOWs”), resource requirements, and backup or data recovery plans.

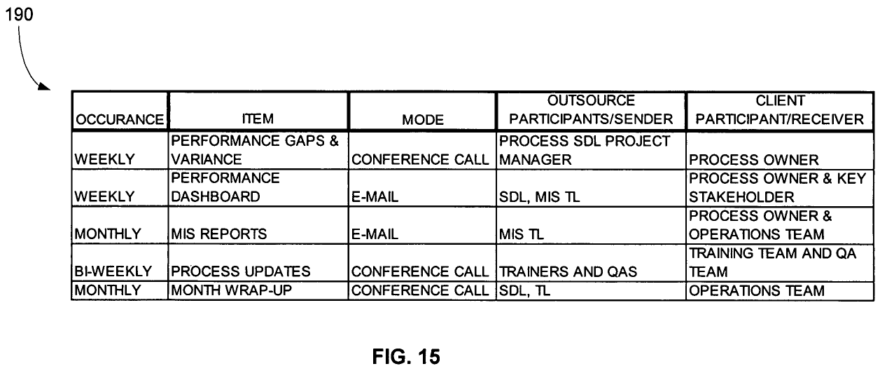

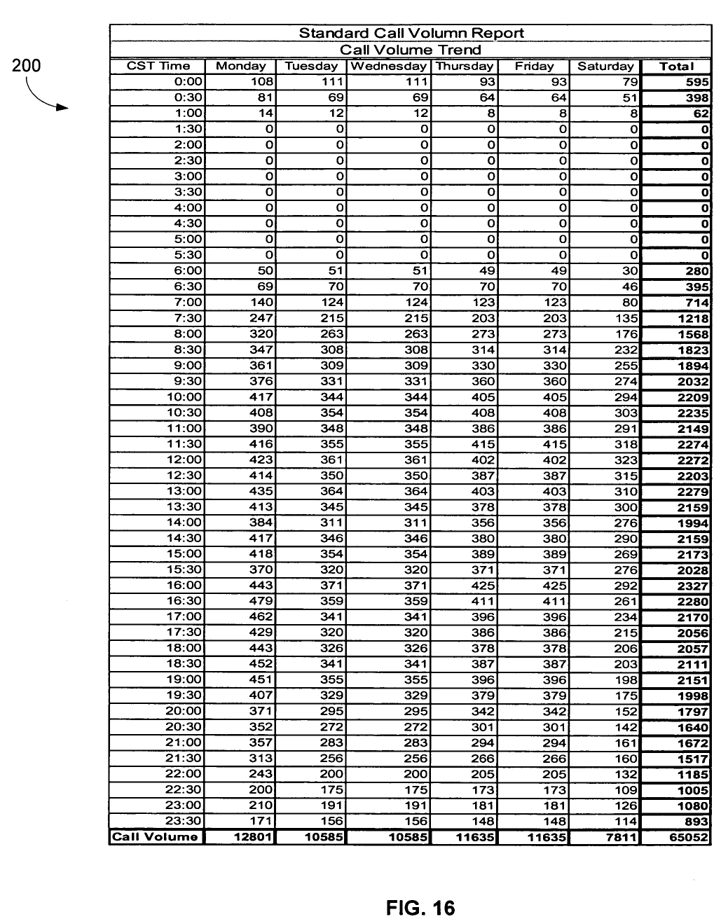

After the project definition step 180, parties can finalize a BPO project transition plan during the knowledge transfer step 184 in order to complete a roadmap, business plan, and detailed procedures for executing a process transition. In some embodiments the knowledge transfer step 184 also includes finalizing point of arrival documentation for a transition team that will handle the transition. During the knowledge transfer step 184, transition teams for each party can exchange information, provide final validation, and perform any pre-implementation activities in order to review and prepare for the transition commnencement. Transition teams can use tools and/or method to finalize process transition, such as establishing and reviewing SIPOC documents, establishing and managing on-site teams at a process owner site and/or an outsourcer site, providing and recording client certification, and training trainers for one or both parties. The knowledge transfer step 184 can encourage one or both parties to create and finalize process diagrams 64, such as one or more of the following: process maps; training manuals; SLA documentation plans that define the transition and any reporting, measurements, and/or sampling that is to take place; process change control procedures; billing and/or commercial plans; technical architecture documentation; exception logs; and system response documentation in order to prepare for process transition commencement. For example, in order to overcome and prepare for misunderstandings and loss of data during and after the process transition, one or more post-outsource or post-deliver communication plans may be generated. An example post-outsource plan 190 is shown in FIG. 15. A post-outsource plan 190 may specify a number of hourly, daily, weekly, and/or monthly status checks and reports that may be executed and evaluated to manage the initial phases of the transition and aid the stabilization thereafter. The status checks and reports specified by a post-outsource plan 190 can include volume reports 200, such as a call volume report, as shown in FIG. 16. A volume report 200 can provide a process owner insight into the operation of a transitioned process in order to stay informed and track the process.

Once one or more roadmaps, business plans, and detailed procedures have been completed and validated, the BPO project can move to a production and or “live” environment where the process is transitioned to the outsourcer during the production step 188. In some embodiments, component testing and/or integration testing and validation can be performed during an initial phase of the production step 188, the implementation of the process transition can occur in phases, and complete process transition is ramped up to a complete transition after initial testing results and process performance results are obtained and analyzed for each phase. Testing can include technical testing and/or user acceptance testing and various plans, tools, and reports can be developed to aid process transition testing. For example, parties can develop a technical testing plan, a user acceptance testing plan, a facilities procurement checklist, a profiling and sourcing plan, a recruitment test design, a training report, a hiring/ramp-up report, a client review report, a facilities readiness checklist, and/or a “go-live” production plan in order to test and review a process transition.

Once test results are obtained, one or both parties can sign off on the test results and can use the test results to develop a ramp-up plan. One or both parties can also establish a hiring plan and/or a detailed training plan for the process transition. In addition, one or both parties can provide sourcing and/or recruitment of best practices, as well as testing of best practices, such as in the area of recruitment, operations, and technology. Furthermore, both parties can review and/or establish professional services automation (“PSA”) procurement processes.

After a process has been transitioned, the results evaluation and ongoing improvement phase 18 (also referred to as the “Post-Transition” phase) can be executed in order to monitor the transitioned process and aid continued process outsourcing success. As shown in FIG. 2, the results evaluation and ongoing improvement phase 18 includes a performance results step 210, a process improvement analysis step 212, an implement process improvement step 214, and an ongoing improvement analysis step 216. During the performance results step 210, one or both parties can review early results in order to measure and identify immediate refinement or re-training needed in order to ensure that variances from expectations are identified and resolved. In some embodiments, refinement and/or re-training opportunities and necessities can be obtained by monitoring the performance of the transitioned process, reviewing preliminary output of the transitioned proces, and monitoring measurable objectives set for the transitioned process. One or both parties can use various monitoring tools and methods, such as SLA standard monitoring, supervisory monitoring, statistical reporting review, benchmarking exercises, systems monitoring, volume forecasting and variances, velocity monitoring, and employee productivity reporting/monitoring. After monitoring the transitioned process, one or both parties can have access to initial assessment reports and variance explanations and can have the ability to monitor objectives that can be used to review the initial results output by the transitioned system in a detailed step-by-step manner.

After the initial monitoring and results analysis performed during a performance results review, full scale process review can be conducted during the process improvement analysis step 212 in order to identify potential improvements, automation, and/or transformation opportunities for the transitioned process. Identified improvements and enhancements can also be rank ordered by importance during this step. In some embodiments, one or both parties involved in the transition can provide situation analysis, including a full-scale review and the establishment of a corresponding action plan. Analyzing statistical reporting output, benchmarking, and/or potential process improvements, process improvements can be identified. In some embodiments, identified process improvements can be ordered based on the complexity of the improvements, the importance of the improvements, the failure rate or the potential rate associated with the improvements, the potential benefit from implementing the improvements, and/or another criteria established by one or more of the parties involved in the transition. In addition, process improvement change management documentation, which includes goals and new metrics, can be created as a plan for reviewing and implementing enhancements and improvements.

After a plan for implementing one or more improvements has been developed, a deployment of one or more improvements can be accomplished during the implement process improvement step 214. In addition, the implement process improvement step 214 can include steps for creating and documenting an implementation plan. In some embodiments, a communication plan for communicating the implementation of an improvement to required parties and establishing a test plan for the improvement implementation are also established during the implement process improvement step 214. Once the plans are established, an improvement implementation can be staged and tested. In some embodiments, an improvement implementation can be tested (e.g., user acceptance testing), and a process owner can review test results in a client review report. If the process owner is pleased with and accepts the improvement implementation based on the testing results, the process owner can sign-off on the improvement and a “go-live” production plan can be established to fully implement the improvement.

During improvement implementation, one or both parties can look for efficiency and quality gains using impact analysis reporting and other forms of reporting, such as training reports and client review reports.

After one or more improvements are implemented during the process improvement step 215, continual process improvement can be exercised as an ongoing practice during the ongoing improvement analysis step 216. The ongoing improvement analysis step 216 can provide a continual feedback loop in order to provide ongoing monitoring, external tools assessment, and/or market needs assessment. Using recurring process reviews and evaluations (e.g., Six Sigma, daily/weekly/periodic output analyses, and SLA performance results), as well as client feedback, an outsourced process can continue to be updated and new goals regarding the process can be established. In addition, continual review and monitoring of an outsourced process can provide linkage to other related processes that may be candidates for outsourcing.

Finally, after the process has been transitioned and has been continually monitored for successful performance and improvement opportunities, the relationship management phase 20 (also referred to as the “Relationship” phase) can be executed in order to continue and expand a relationship between a process owner and an outsourcer. As shown in FIG. 2, the relationship management phase 20 includes a partnership step 220 and an ongoing services step 224. During the partnership step 220, an outsourcer can establish an ongoing partnership with a process owner in order to further understand needs of the process owner and help deliver solutions to the process owner for those needs from a pre-transition phase through a post-transition phase. In addition to discussing the performance of current process transitions, an outsourcer can also attempt to further understand business requirements and expectations of a process owner, which the outsourcer can then use to develop and negotiate existing contracts as well as further contracts. An outsourcer can also use knowledge gained during the partnership step 220 in order to help identify and support new opportunities for process transitions and/or other services provided by the outsourcer. Using on-site meetings with a process owner, coordination of ongoing communication and meetings, contractual agreement discussions, and regular reporting and discussions on contractual agreement performance, an outsourcer can attempt to ensure that a process owner is satisfied with the service provided by an outsourcer and will provide additional business to the outsourcer. As a result of furthering a partnership created between an outsourcer and a process owner, an outsourcer can generate contractual agreements, such as SLAs and KPIs, that are understood and met by both parties. In some embodiments, one or more post-outsource plans, such as the post-outsource plan 190 shown in FIG. 15, and/or volume reports, such as the volume report 200 shown in FIG. 16, can be used to continually review and/or measure process transition results.

Once a solid partnership is formed between an outsourcer and a process owner, ongoing communication and issue management can be executed during the ongoing services step 224 in order to ensure process owner satisfaction. In some embodiments, an outsourcer can meet regularly with a process owner (e.g., key stakeholders) in order to facilitate the resolution of issues, provide accurate and timely invoicing, and coordinate ongoing meetings and reporting that keeps a process owner informed and satisfied with services/products provided by the outsourcer. Using regularly-scheduled process, strategy, and update meetings, an outsourcer can be a voice of a process owner within an outsourcing party and can generate issue management lists and regular account reviews for invoices. As a result of providing ongoing communication, both parties can understand current service performance and an outsourcer can provide timely identification and resolution of issues and concerns, as well as accurate invoicing.

It should be understood that other reports, specifications, and guidelines may also be created through the BPO project other than those discussed and illustrated and that the order and content of each of the BPO project step/phase as described herein can be configured in various sequences and/or combined and distributed into fewer or additional steps.

Various features of the invention are set forth in the following claims.

1. A method for determining an outsourcing readiness for at least one business process, the method comprising:
defining process characteristics for at least one business process;
determining a readiness index for the at least one business process based on the process characteristics; and
ranking the at least one business process according to the readiness index.

2. The method of claim 1 and further comprising grouping the process characteristics into at least one characteristic group, each characteristic group having a weighting.

3. The method of claim 2 wherein the at least one characteristic group includes at least one of an operational impact group, a strategic drivers group, an outsourcing readiness group, an environment group, and an opportunity for automation and re-engineering group.

4. The method of claim 2 wherein determining a readiness index for the at least one business process includes determining a sum of the process characteristics included in the at least one characteristic group.

5. The method of claim 4 wherein determining a readiness index for the at least one business processes includes determining a weighted sum for the at least one characteristic group by multiplying the sum of the at least one characteristic group with the weighting of the at least one characteristic group.

6. The method of claim 5 wherein determining a readiness index for the at least one business process includes determining a composite sum of each of the weighted sums.

7. The method of claim 1 and further comprising choosing at least one candidate business processes from the at least one business process, the candidate business process having a readiness index indicating an ability to outsource the process.

8. The method of claim 7 and further comprising defining a project of outsourcing the at least one candidate business process.

9. The method of claim 8 and further comprising transferring knowledge concerning the at least one candidate business process to an outsource provider.

10. The method of claim 9 and further comprising transferring control of the at least one candidate business process to the outsource provider.

11. The method of claim 10 and further comprising recording performance data regarding the at least one candidate business process controlled by the outsource provider.

12. The method of claim 11 and further comprising stabilizing the at least one candidate business processes based on the performance data.

13. The method of claim 1 and further comprising displaying, the at least one business process ranked according the readiness index for business process.

14. A system for determining an outsourcing readiness for at least one business process, comprising:
an input/output module configured to receive process characteristics associated with at least one business process, and
a process readiness index calculating tool including a processor configured to receive the process characteristics, determine a readiness index for the at last one business process based on the process characteristics, and rank the at least one business process according to the readiness index.

15. The system of claim 14 wherein the processor is further configured to group the process characteristics into at least one characteristic groups, where each characteristic group has a weighting.

16. The system of claim 15 wherein the processor is further configured to group the process characteristics into at least one characteristics group including at least one of an operational impact group, a strategic drivers group, an outsourcing readiness group, an environment group, and an opportunity for automation and re-engineering group.

17. The system of claim 15 wherein the processor is further configured to determine a sum of the process characteristics included in the at least one characteristic group.

18. The system of claim 17 wherein the processor is further configured to determine a weighted sum for the at least one characteristic group by multiplying the sum of the least one characteristic group with the weighting of the at least one characteristic group.

19. The system of claim 18 wherein the processor is further configured to determine a composite sum of each of the weighted sums.

20. The system of claim 14 wherein the input/output module is further configured to output a ranking of the at least one business process according the readiness index for the at least one business process.

21. The system of claim 20 and further comprising an output device configured to display the ranking.

22. A computer readable medium containing instructions for determining an outsourcing readiness for at least one business process, the instructions comprising:
defining process characteristics for the at least one business process;
determining a readiness index for the at least one business process based on the process characteristics; and
ranking the at least one business process according to the readiness index.

23. The computer readable medium of claim 22 and further comprising instructions for grouping the process characteristics into at least one characteristic group, the at least one characteristic group having a weighting.

24. The computer readable medium of claim 23 and further comprising instructions for grouping the process characteristics into at least one characteristic group including at least one of an operational impact group, a strategic drivers group, an outsourcing readiness group, an environment group, and an opportunity for automation and re-engineering group.

25. The computer readable medium of claim 24 and further comprising instructions for determining a sum of the process characteristics included in the at least one characteristic group.

26. The computer readable medium of claim 25 and further comprising instructions for determining a weighted sum for the at least one characteristic group by multiplying the sum of the at least one characteristic group with the weighting of the at least one characteristic group.

27. The computer readable medium of claim 26 and further comprising instructions for determining a composite sum of the weighted sums.

28. The computer readable medium of claim 22 and further comprising instructions for displaying the at least one business process ranked according the readiness index for the at least one business process.
